(19) United States
(12) Patent Application Publication
(10) Pub. No.: US 2016/0173025 A1
(43) Pub. Date: Jun. 16, 2016

(54) SOLAR POWER PLANT

(71) Applicant: DHP TECHNOLOGY GMBH, Grüsch (CH)

(72) Inventors: Franz Baumgartner, Konstanz (DE); Arthur Buchel, Balzers (LI)

(21) Appl. No.: 14/889,591

(22) PCT Filed: Dec. 3, 2013
(86) PCT No.: PCT/CH2013/000208

§ 371 Date: Nov. 6, 2015

(30) Foreign Application Priority Data
May 6, 2013 (EP) 13166708.1

(51) Int. Cl. H02S 30/20; H02S 20/20

(52) U.S. Cl. CPC H02S 30/20; H02S 20/20

(57) ABSTRACT

The invention relates to a solar power plant having a plurality of solar panels arranged in a row and at least one holding element on which the solar panels are held one after the other. The solar panels can be displaced along the at least one holding element with engagement means from an extracted operating position into a retracted resting position.

### CROSS-REFERENCE TO RELATED APPLICATIONS

This application is a national phase entry under 35 U.S.C. §371 of PCT/CH2013/000208 filed on Dec. 3, 2013, which claims priority to European Patent Application 13166708.1 filed on May 6, 2013, the entirety of each of which is incorporated by this reference.

### FIELD OF THE INVENTION

The invention relates to a solar power plant.

### PRIOR ART

Solar power plants are known from the prior art, for example, WO 2010/006460, in which solar panels are swivel-mounted on ropes stretched between two support posts. Such solar power plants have the disadvantage that they form a large engagement area for wind and snow. The supporting structure must accordingly be designed sturdily, so that wind and weather cannot damage the solar power plant. Accordingly, such a sturdy weather-resistant solar power plant is expensive.

Solar modules are known from JP 2003318430, which are connected by pairs of hinges provided on opposite sides. The plurality of solar modules has foldable electric connection means on the coupling section of the hinges. Furthermore, the solar modules include guidance devices on both sides, which are oriented orthogonally to both sides, on which the hinges are provided. The guidance means interact with wire ropes, which are provided as guidance rails for the solar modules.

A retractable solar panel system is shown in US 2010/0065104. The solar panels are combined in pairs, wherein the individual pairs are connected to each other by a joint. The system also comprises a device for the retraction and extension of the solar panel pairs connected to each other in a jointed manner, for example, a telescopable sailing mast. The solar panels can, therefore, be converted into a stack, if they are not in use.

EP 2020467 describes an awning with a sun roof and a supporting structure for the sun roof. The sun roof can be extended or retracted cross braces along the supporting structure. On the side of the sun roof facing the sun, solar panels are positioned in such a way that they do not impede the folding up of the sun roof.

WO/2011059062 discloses a solar power plant with a plurality of solar panels suspended in the air. The solar panels are foldably connected to each other and are suspended between two masts. The air underneath the solar panels serves for their cooling. The solar panels can be folded together in a housing.

Problem Addressed by the Invention

The problem addressed by the present invention, therefore, is to propose a solar power plant, which improves the protection of the solar panels in adverse weather conditions (wind, snow, sand or ice).

### SUMMARY OF THE INVENTION

The solar power plant according to the invention comprises a housing, in which the solar panels are accommodated in their resting position. The housing protects the solar panels not only against wind and weather and their effects on a possible damaging of the solar power plant, but also has the effect that the solar panels are even less severely soiled. This is due to the fact that the solar panels are not constantly exposed to the environment, but rather are retracted at least in the night in the protected position. Also, in the case of weather conditions such as rain, wind, sandstorm, or the like, the solar panels will be retracted, in order to protect them against soiling. The housing, therefore, also acts as a preventive protective measure against soiling. It is also conceivable that in a housing of two sides, solar panels are accommodated in a protected position and are drawn from both opposite sides into operating positions. The solar panels can also be partially replaced by plate elements, which do not carry solar cells.

The ability to shift between the operating and resting position has the effect that the load on the solar power plant as a result of weather influences such as wind, rain or snow can be reduced, since the solar panels offer no or a small engagement surface in the protected resting position. The dimensioning of the solar power plant according to the invention, in order to obtain sufficient stability, can therefore be reduced compared to solar power plants of the prior art described above. This reduced dimensioning leads to lower production costs for the solar power plant. The maintenance costs can also be reduced since damages as a result of weather influences can be prevented for the most part in the case of the solar power plant according to the invention. Rope pulls, chains, toothed racks, extendable telescopic arms or folding grille mechanisms are conceivable as engagement means, which move the solar panels into the two end positions or positions between them.

In one embodiment an essentially vertically oriented protective plate is fixed on the outermost solar panel, seen from the housing. During a moving of the outermost solar panels, the protective plate is movable with the latter. This protective plate has the advantage that the closure of the housing by the protective plate takes place automatically, without a cover having to be opened or closed. Therefore, movable additional parts or cover controls or damper drives can be dispensed with. The protective plate is, therefore, not susceptible to failure and maintenance free. It is also conceivable that the outermost solar panel is reinforced, for example, with ribs and thus acts as a protective plate. An additional protective plate is no longer necessary in this case.

The protective plate is advantageously locked in place with the housing, if the solar panels are located in the protected position. The latching can be achieved through a closure or a locking device. The latching has the effect that the solar panels are reliably covered in the housing and weather influences cannot open, damage or tear off the protective plate.

It is advantageous if the protective plate can be locked in place with the housing by means of a snap lock, which snap lock opens or closes in the case of a defined load. Through the contact pressure, which is built up on the snap lock during the retraction and extension the housing can be automatically closed or opened by the protective plate, without additional locking mechanisms being necessary.

In another embodiment, the solar panels are accommodated in the resting position in a housing that can have a movable protection element. The locking element can assume the function of the protective plate. In the resting position the solar panels are therefore well protected even if a storm or other extreme weather conditions should exist. A cover serves as a movable protective element, whereby the receiving opening of the housing is also lockable, after the folded up solar panels were accommodated in the housing.

Advantageously, adjacent solar panels are connected with each other in such a way that a thrust force or compressive force can be transferred from a solar panel or a pressure- or thrust-transferring retaining element to an adjacent solar panel or an adjacent pressure- or thrust-transferring retaining element. The engagement means can therefore be arranged on an end of the solar panel arrangement and can move all solar panels by application of a thrust force or compressive force. A pressure- and thrust-transferring retaining element can, for example, be a folding grille or a telescopic rod.

In another embodiment adjacent solar panels are connected with each other on their side edges facing each other in the manner of a folding roof through first and second alternating joints. In the resting position the solar panels can be pushed together into a small packet which offers a small engagement surface for the wind. In the operating position the solar panel arrangement has a large surface, since it is completely deployed, whereby an as large a surface as possible is facing the sun. It is understood that as already explained above, not every supporting element of the folding roof or of the folding gate, which is arranged between a first and a second joint must be equipped with solar cells. Supporting elements can therefore also be partially free of solar cells.

In another embodiment the solar panels with sliding elements are located movably on the at least one retaining element and the first joints are arranged on the sides of the sliding elements facing away from the retaining element. Thus, the first joints are arranged above the guide rope. This arrangement has the effect that a shading of the guide rope on the solar panels, which would worsen the efficiency of the solar power plant, is prevented as far as possible. The height of the sliding elements is selected such that in the case of a flat angle of incidence of the sun of max. 25° to the horizon no shading is caused on the active cell surface, or in the case of an angle of incidence of 15° or in the case of an angle of incidence of 10° or less.

Advantageously, a solar panel is a flat plate with two essentially parallel flat sides, wherein at least on one of the flat sides a plurality of photovoltaic cells is arranged. Thus, an as dense an arrangement of photovoltaic cells as possible can be realised in a narrow space. Distances between the cells can make it possible that a part of the solar radiation can penetrate through the plate (if it is transparent) onto the bottom area.

Advantageously, solar panels of the same angular orientation are connected to each other electro-conductively. Flexible cable lines are conceivable which do not prevent the swiveling of the solar panels relative to each other and are not snapped off by the swiveling. Advantageously, solar panels of the same angular orientation are coupled to a line in order to connect solar panels with the same or similar electrical output with each other. Also, adjacent solar panels can be directly connected electrically with each other.

It has proven to be advantageous if at least every 10^{th} solar panel folding element is movable on the at least one retaining element. It is also conceivable that all solar panels or every second solar panel is held movably on the retaining element, if the stability of the solar power plant requires it.

As a result of the fact that the retaining element is a guide rope or a guide rod, the solar panels are held sufficiently securely and are linearly movable along the guide rope or the guide rod. A guide rope or a guide rod is cost-effective and can be rapidly mounted on support posts or flat surfaces, for example, roofs. The guide rope or the guide rod can not only be arranged on the hinges, but rather can be located, as commonly used in the case of folding gates, in the centre of the lateral side edges of the solar panels. Advantageously, the retaining element can also be a telescopic rod or a folding grille, if an increased stability is required by the retaining element.

In another embodiment, the transfer from the operating position into the resting position and vice versa occurs by means of a drive, in particular, an electrical drive. The electrical drive can easily be controlled and can move the solar panels depending on meteorological measuring data or sensor data fully automatically between the end positions or into intermediate positions.

Advantageously, the switch between the operating position and the resting position can be carried out by a control, which evaluates local sensor signals and/or local or supra-regional meteorological data via a network. The solar panels can, therefore, be transferred into the desired position, for example, depending on threshold values, which are compared with the measuring values of the sensors, or the combination and case-by-case analyses of several meteorological measurements, in order, for example, to detect the approach of a storm front, gusts of wind or hail. The solar panels can, therefore, be fully automatically moved into the operating position or into the resting position depending on the existing weather conditions, without monitoring by personnel being necessary.

Advantageously, the sensors record the wind speeds, amount of ice, amount of snow, amount of precipitation, temperature, humidity, lightning activities and solar radiation. The sensor signals can also be usefully coupled with each other, whereby conditions can be defined, in order to immediately detect critical weather situations, in order to achieve an optimum between safe operation and safekeeping in the resting position. The classified weather situation also decides on the minimum duration of the retention time in the resting position. The recoding of these data is sufficient to protect the solar power plant against influences which could damage the solar power plant or could destroy it in the case of storms, hail, snow or other adverse conditions. Depending on the existing solar radiation, solar panels are also optionally movable into a different intermediate position, in order to produce an optimal angle to the sun. It is also conceivable that the solar power plant has an interface for an Internet connection. Thus, meteorological data from the Internet can also be used for control of the solar panel position.

It is also advantageous, if the solar power plant is equipped with an emergency power supply. In particular, the retraction mechanism then continues to function, even if the power supply is interrupted. Damage to the solar power plant is, therefore, also prevented in the case of a power failure, since the solar panels can also be transferred into the resting position in the case of a power failure.

Advantageously, the solar power plant includes a cleaning system, which cleans the solar panels of soiling. Sand, snow, bird droppings, air pollution or other soiling, which impair the performance of the solar power plant, can, therefore, be removed without the use of personnel.

The cleaning system advantageously includes at least one mechanical cleaning system, a cleaning by means of liquid or by means of compressed air and monitoring sensors for recording the cleanliness. These systems make it possible for the solar power plant to be cleaned automatically, if the fronts of the solar panels 19 are soiled. The principle can function similarly to a windscreen wiper of a passenger car.

It has also proven to be advantageous, if a protection device, in particular, a net or a tarpaulin-like canopy is located between support posts. The support posts can serve as a retaining element for a bird or hail net. A surface area used agriculturally beneath the solar power plant is, therefore, protected against bird feeding and precipitations. The protection device or the net can be clamped long-term or can be located on an end support capable of being rolled up.

A further aspect of the invention relates to a method for the prevention of soiling of the surfaces of the solar panels in order to prevent damage to the solar panels of a solar power plant by wind, snow or ice loading, in which the solar panels are moved into a housing when transferred into the resting position. The housing is closed by a protective plate arranged on the last solar panel, if the solar panels are in the resting position. A protection of the solar panels, therefore, occurs automatically in the resting position from all sides, without further protection devices needing to be pulled over the solar panels.

Advantageously, the transfer into the resting position and out of the resting position depending on local weather influences is controlled by a control. Soiling can be prevented by the control, since the solar panels are in the resting or in the protected position, if weather conditions exist at the location of the solar power plant, which could lead to a soiling of the solar panels. Among these weather influences is also the steaming up of the solar panels with steam, since the condensation water can stick together with sand and other air pollutants. Since the solar panels are in the protected position overnight, or at times when the air humidity exceeds a threshold value, a steaming up of the solar panels can be prevented in the operating position.

### BRIEF DESCRIPTION OF THE DRAWINGS

Further advantages and features result from the following description of several embodiments of the invention referring to the schematic representations. In these—not to scale:

FIG. 1: shows a side view of an embodiment of the solar power plant according to the invention;

FIG. 2: shows a top view of the solar power plant from FIG. 1;

FIG. 3: shows an axonometric view of the pushed-together solar panels with a protective plate;

FIG. 4: shows an axonometric view of the solar power plant with raised sliding elements;

FIG. 5: shows an individual solar panel in a side view;

FIG. 6: shows a top view of a large-scale plant and

FIG. 7: shows a side view of the large-scale plant from FIG. 7.

### DETAILED DESCRIPTION OF THE ILLUSTRATED EMBODIMENTS

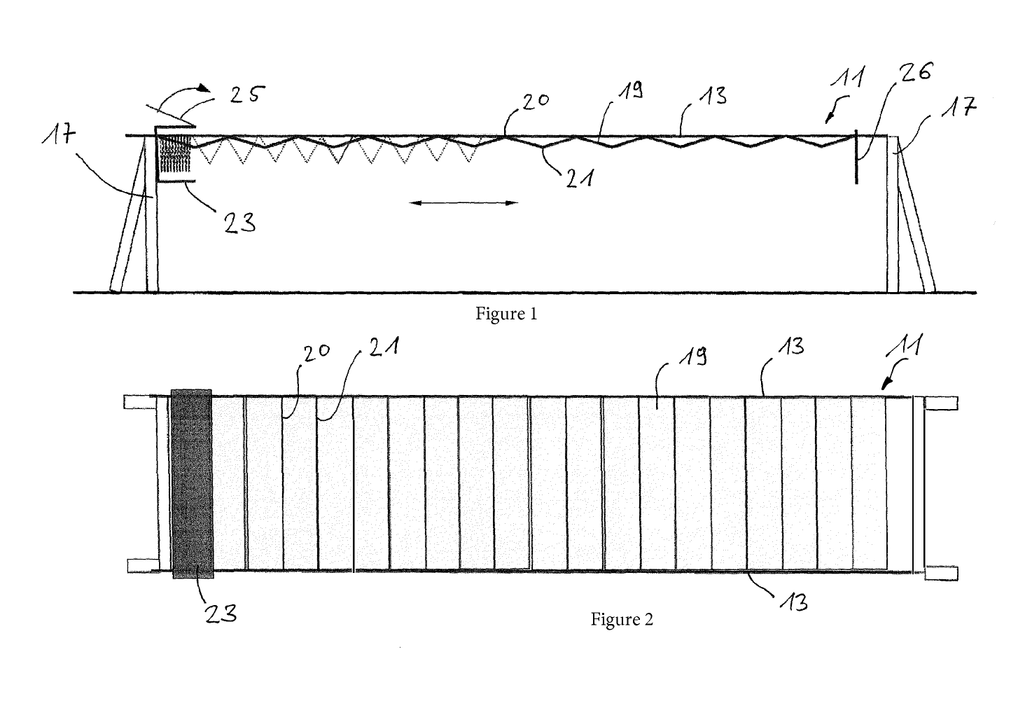

FIGS. 1 and 2 show an embodiment of the solar power plant according to the present invention, which is designated as a whole with the reference sign 11. In this embodiment two essentially parallel running guide ropes or guide rods 13 are provided as retaining elements. The guide ropes or rods 13 are stretched or run between two posts 17. It would also be conceivable, that the guide rods 13 are located on a flat surface area, for example, on a roof, without posts 17 being used.

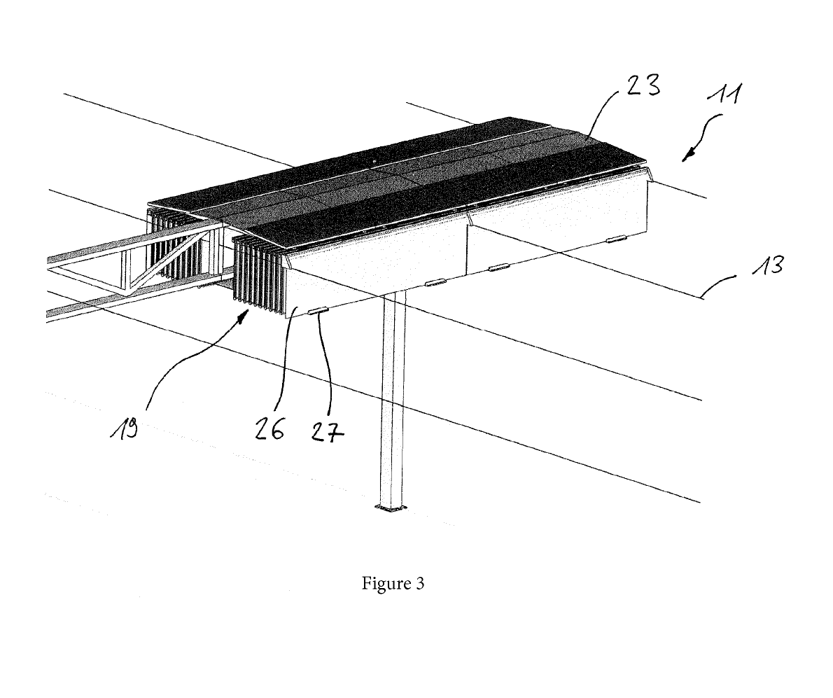

A plurality of solar panels 19 arranged in a row is held on the guide ropes or guide rods 13. If in the framework of this application a solar panel 19 is spoken of, then a plate with two essentially parallel flat sides is thus disclosed, wherein a plurality of photovoltaic cells is arranged on at least one flat side. FIGS. 1 and 3 show adjacent solar panels 19 that are connected to each other in a jointed manner. The jointed connection can be designed, for example, as a hinge 20, wherein bushings 22 attached on the facing side edges are connected with each other rotatably by means of a bolt. The solar panels 19 are connected to each other in a jointed manner such that they can be pushed together or apart in a fan-like manner. Accordingly, the entirety of solar panels 19 can be moved from an extracted operating position into a retracted resting position and vice versa and can also be transferred into an intermediate position (FIGS. 1 and 3). The housing 23 can be deemed to be a device for the prevention of the soiling of the solar panels 19, since the solar panels 19 are retracted at least overnight into the housing. Thus, the time in which the solar panels 19 are exposed to contaminating environmental influences is reduced by the protective housing 23. The housing is, therefore, a preventive cleaning measure.

In the operating position, the solar panels 19 with the verticals enclose an angle of greater than 75 degrees. So that the solar panels in the resting position need as little space as possible, in this position they enclose an angle with the verticals, which is less than 10 degrees (FIG. 3). In the resting position the solar panels 19 are accommodated in a housing 23. The housing offers the solar panels 19 protection against wind and precipitation. The resting position, therefore, also performs the function of a protected position. The housing 23 can also still have a cover 25, in order to completely protect the bellows of solar panels 19. The cover 25 can seal the receiving opening of the housing 23, after the bellows are accommodated in the housing. The roof of the housing is also advantageously used with solar modules, which, however, are firmly installed.

Instead of the cover 25, a vertical protective plate 26 is located on the outermost solar panel, seen from the housing 23. The protective plate 26, therefore, moves with the solar panels 19 from the operating position into the protective position and vice versa. The solar panels 19 are therefore always automatically completely covered by the protective plate 26 in the housing 23. A cover, which constitutes an additional fault-prone component, can, therefore, be avoided. The protective plate 26 automatically locks the snap-in lug in place during the retraction of the last solar panel 19 into the housing 23. The snap-in lugs 27 have the function of a snap lock, i.e., they hold the protective plate 26 up to a certain load and release the protective plate 26, if a certain load is exceeded. With the retraction of the last solar panel 19 into the housing the resistance of the snap-in lug is automatically overcome by the contact pressure of the protective plate 26 and the protective plate 26 closes the housing 23. With the extension from the protected position the retaining pressure of the snap-in lugs 27 is overcome and the solar panels 19 can be extended from the protected position, without any additional process steps being necessary for opening the protective plate 26. Flexible plastic projections are conceivable as snap-in lugs, however, pre-stressed projections are desirable, for example, by springs, which are swiveled by the contact pressure of the protective plate during the retraction or extension and then snap back again into the closure position.

It is advantageous if the solar panels 19 have no glass cover, since these can be pushed together further in the resting position due to their minimal thickness, than is the case when a glass cover is present. The protection of a glass cover is not mandatory anyway in the case of the solar power plant 11 according to the invention, since in adverse weather conditions the solar panels 19 are retracted into the housing 23. Adjacent solar panels 19 are electrically connected with each other without the pushing together or the pulling apart of the solar panels 19 being thus impaired. In particular, cables are suitable for the electrical connection.

During the movement into the protected or into the working position the solar inverter can be switched off in order to exclude possible electrical dangers.

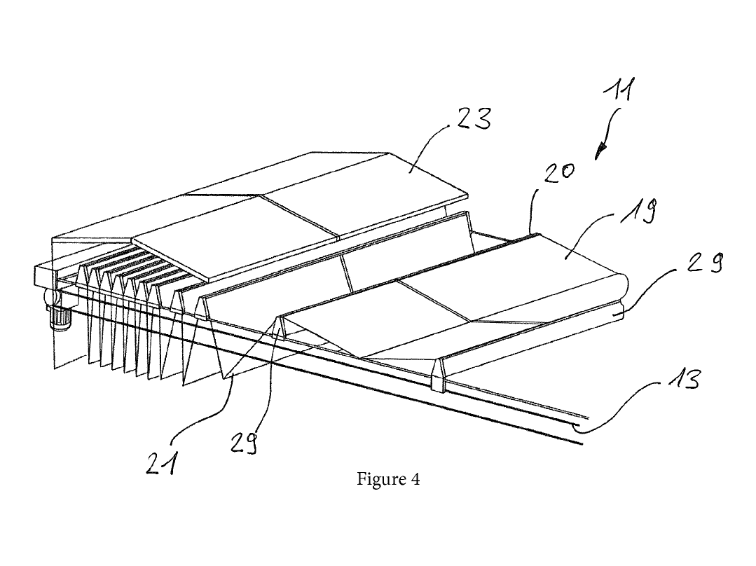

In FIG. 4, a suspension of the solar panels 19 is shown, which prevents the guide ropes 13 from casting a shadow on the solar panels 19. The overhead first joints or hinges 20, which connect adjacent solar panels 19 in a jointed manner, are arranged raised on sliding elements 29. The second joints or hinges 21 positioned beneath are freely suspended, since only the first hinges 20 are connected with the guide ropes 13. Therefore, a height distance is formed between the guide ropes 13 and the hinge axes by the sliding element 29, which is selected such that with a flat angle of incidence of the sun of max. 25° with respect to the horizon no shading is caused on the active cell surface areas, or with an angle of incidence of 15° or with an angle of incidence of 10° or less no shading is caused on the solar cells.

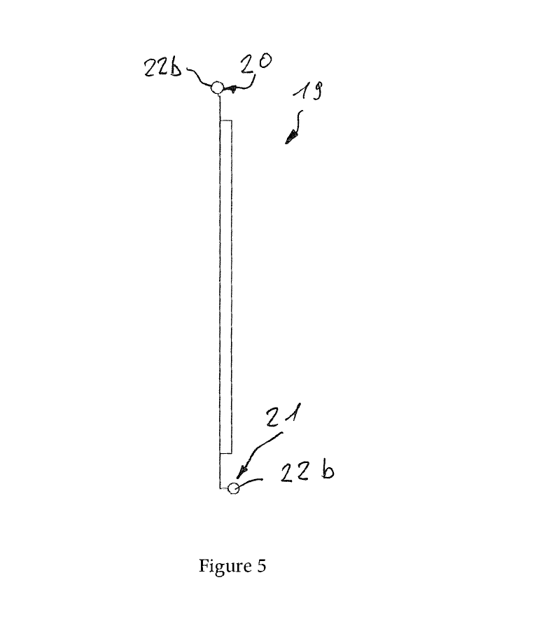

In FIG. 5, an individual solar panel 19 is shown with two bushings 22a, 22b arranged on opposite sides, which together with bushings of adjacent solar panel 19 form the first and second hinge 20, 21. The bushings are thereby arranged offset in such a way that they interact with bushings of adjacent solar panels 19 in a space saving manner.

It is not necessary for the movable bracket of the solar panels 19 connected with each other in a jointed manner on the guide rope or the guide rod 13 that each solar panel 19 is held on the retaining element. Thus, only every second or third solar panel 19 can be held on the retaining element. However, for a bracket that bears the entire weight of the solar panels 19 it is desirable that every tenth solar panel 19 is held on the retaining element. For example, eyelets, hooks or sliding elements 29 can serve as the bracket on the solar panels 19, through which the retaining elements 13 are guided.

The fan-like pushing together of the solar panels 19 is especially suitable for protecting the solar power plant 11 against damage due to weather influences. Advantageously, the solar power plant 11 is, therefore, monitored and controlled by local sensors or supra-regional weather information. The sensors monitor meteorological values such as wind speed, snowfall, amount of precipitation, temperature, air humidity, etc. If the recorded values exceed or fall below reference values stored in a data bank or combinations and correlations of several weather indicators, then the solar panels 19 are automatically retracted or extended. An electrical drive may be actuated by the sensors. The electrical drive is connected with engagement means to the solar panels 19, in order to shift the solar panels 19 automatically between the resting position and the operating position. For example, a rope, a chain or a toothed rod can serve as engagement means for the transfer of thrust forces or tensile forces. However, the solar panels can also be shifted with the engagement means into any position between the two end positions. This makes sense in order to move the solar panels 19 into an optimal angle to the sun. The radiation angle of the sun can be recorded by means of a sensor for this.

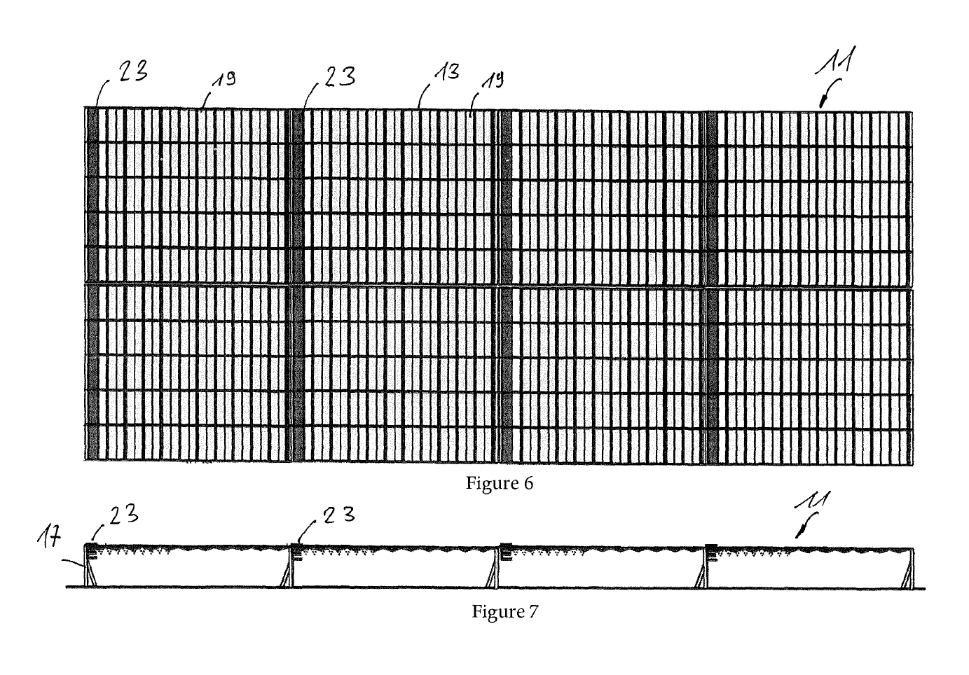

In FIGS. 6 and 7 it is shown how individual solar power plants can be assembled side by side or in a row at a large-scale plant. In this embodiment 40 solar power plant fields 11 are arranged side by side or in a row. Advantageously, it is provided that with a drive unit several solar power plant units can be retracted or extracted synchronously in the direction of the extraction movement and/or parallel thereto.

1-14 (canceled)

15. A solar power plant, comprising
a plurality of solar panels arranged in a row;
at least one retaining element on which the plurality of solar panels are held and along which the solar panels can be moved with an engagement mechanism from an extended operating position to a retracted resting position;
a housing in which the plurality of solar panels are accommodated in the retracted resting position; and
a protective plate coupled to an outermost solar panel, relative to the housing, of the plurality of solar panels and during movement of the outermost solar panel, the protective plate is movable therewith.

16. The solar power plant of claim 15, wherein when the plurality of solar panels are located in the retracted resting position, the protective plate is locked in place to the housing by a closure mechanism or a locking mechanism.

17. The solar power plant of claim 16, wherein the protective plate can be locked in place by a snap lock, the snap lock opening or closing at a defined load.

18. The solar power plant of claim 15, wherein adjacent solar panels of the plurality of solar panels are connected to each other in such a way that a thrust force or compressive force is transferred from one solar panel to another solar panel, from one solar panel to a pressure- or thrust-transferring retaining element to an adjacent solar panel or from one pressure- and thrust-transferring retaining element to an adjacent pressure- and thrust-transferring retaining element.

19. The solar power plant of claim 15, wherein adjacent solar panels of the plurality of solar panels are connected to one another at their respective adjacent side edges by first and second joints, respectively.

20. The solar power plant of claim 19, wherein the plurality of solar panels are movable relative to the at least one retaining element with a plurality of sliding elements on the at least one retaining element and that the first joints of the plurality of solar panels are arranged on sides of the sliding elements facing away from the at least one retaining element, whereby casting of a shadow of one or more of the plurality of retaining elements onto one or more of the plurality of solar panels is prevented.

21. The solar power plant according to claim 15, wherein each of the plurality of solar panels comprises a substantially flat plate having two substantially parallel and substantially flat sides and a plurality of photovoltaic cells arranged on at least on one of the two substantially flat sides.

22. The solar power plant of claim 15, wherein each of the plurality of solar panels of a same angular orientation is connected to each other electro-conductively.

23. The solar power plant of claim 15, further comprising a control to control movement of the plurality of solar panels between the operating position and the resting position, the control configured to evaluate local sensor signals or local or supra-regional meteorological data via a network and to move the plurality of solar panels between the operating position and the resting position according to an evaluation of the local sensor signals or local or supra-regional meteorological data.

24. The solar power plant of claim 15, further comprising a plurality of support posts for supporting the at least one retaining element and further comprising a protective device extending between the plurality of support posts.

25. A solar power plant, comprising:
a plurality of solar panels arranged in a row;
at least one retaining element on which the plurality of solar panels are held and along which the solar panels can be moved with an engagement mechanism from an extended operating position to a retracted resting position; and
a housing in which the plurality of solar panels are accommodated in the retracted resting position;
wherein, an outermost solar panel, relative to the housing, of the plurality of solar panels is reinforced to act as a protective plate.

26. The solar power plant of claim 25, wherein when the plurality of solar panels are located in the retracted resting position, the outermost solar panel is locked in place to the housing by a closure mechanism or a locking mechanism.

27. The solar power plant of claim 25, wherein the outermost solar panel can be locked in place by a snap lock, the snap lock opening or closing at a defined load.

28. The solar power plant of claim 25, wherein adjacent solar panels of the plurality of solar panels are connected to each other in such a way that a thrust force or compressive force is transferred from one solar panel to another solar panel, from one solar panel to a pressure- or thrust-transferring retaining element to an adjacent solar panel or from one pressure- and thrust-transferring retaining element to an adjacent pressure- and thrust-transferring retaining element.

29. The solar power plant of claim 25, wherein adjacent solar panels of the plurality of solar panels are connected to one another at their respective adjacent side edges by first and second joints, respectively.

30. The solar power plant of claim 29, wherein the plurality of solar panels are movable relative to the at least one retaining element with a plurality of sliding elements on the at least one retaining element and that the first joints of the plurality of solar panels are arranged on sides of the sliding elements facing away from the at least one retaining element, whereby casting of a shadow of one or more of the plurality of retaining elements onto one or more of the plurality of solar panels is prevented.

31. The solar power plant according to claim 25, wherein each of the plurality of solar panels comprises a substantially flat plate having two substantially parallel and substantially flat sides and a plurality of photovoltaic cells arranged on at least on one of the two substantially flat sides.

32. The solar power plant of claim 25, wherein each of the plurality of solar panels of a same angular orientation is connected to each other electro-conductively.

33. The solar power plant of claim 25, further comprising a control to control movement of the plurality of solar panels between the operating position and the resting position, the control configured to evaluate local sensor signals or local or supra-regional meteorological data via a network and to move the plurality of solar panels between the operating position and the resting position according to an evaluation of the local sensor signals or local or supra-regional meteorological data.

34. A solar power plant, comprising:
a plurality of solar panels arranged in a row;
at least one retaining element on which the plurality of solar panels are held and along which the solar panels can be moved with an engagement mechanism from an extended operating position to a retracted resting position; and
a housing in which the plurality of solar panels are accommodated in the retracted resting position;
a movable closure element coupled to the housing, the movable closure element providing a protective plate for the plurality of solar panels in the retracted resting position.
